(19) United States
(12) Patent Application Publication
(10) Pub. No.: US 2016/0274617 A1
(43) Pub. Date: Sep. 22, 2016

(54) BANDGAP CIRCUIT

(71) Applicant: SANJAY KUMAR WADHWA, Noida (IN)

(72) Inventor: SANJAY KUMAR WADHWA, Noida (IN)

(21) Appl. No.: 14/660,915

(22) Filed: Mar. 17, 2015

(51) Int. Cl. G05F 3/30

(52) U.S. Cl. CPC G05F 3/30

(57) ABSTRACT

A bandgap circuit has a pair of NPN bipolar devices that are connected to (i) generate a base-to-emitter voltage difference that is applied across an output-stage resistor and (ii) function as input devices for an amplifier stage that ensures that sufficient current is driven across the output-stage resistor to maintain a desired voltage difference. The desired voltage difference, which has a positive temperature coefficient, is combined with a base-to-emitter voltage of another NPN bipolar device having a negative temperature coefficient to provide a bandgap voltage that is substantially impervious to variations in operating temperature, voltage, and process corners. By using the same two bipolar devices to provide two different functions, there is no need for a separate CMOS-based opamp, which reduces the sources of process mismatch that can adversely affect the bandgap voltage compared to conventional bandgap circuits having bipolar devices and a separate CMOS-based opamp.

### BACKGROUND

The present invention relates to integrated circuits and, more particularly, to a bandgap circuit that generates a bandgap reference voltage.

A bandgap circuit provides a reference voltage, referred to as a bandgap voltage Vbg, that ideally is constant across process, voltage, and temperature (PVT). Bandgap circuits are essential building blocks in many analog circuits such as analog-to-digital converters (ADCs), regulators, and memories. Bandgap circuits are also used to generate reference currents, for example, by driving the generated bandgap voltage across an output resistance.

FIG. 1 is a schematic circuit diagram of a conventional bandgap circuit 100. As shown in FIG. 1, the bandgap circuit 100 has three PMOS (p-type metal oxide semiconductor) transistors MP1, MP2, and MP3 configured as current mirrors. If MP1, MP2, and MP3 are all the same size, the currents flowing through these three devices will all be the same. Note that the current through MP1 also flows through PNP bipolar transistor Q1, the current through MP2 also flows through resistor R1 and PNP bipolar transistor Q2, and the current through MP3 also flows through resistor R2 and PNP bipolar transistor Q3. Note further that the emitter area of transistor Q2 is m times larger than the emitter area of transistor Q1, where m is greater than one.

The bandgap circuit 100 also includes a CMOS-based operational amplifier (opamp) 102, which is connected to drive its two input voltages at nodes A and B to be substantially equal to one another. Since the emitter of Q2 is m times larger than the emitter of Q1, the base-to-emitter voltage Vbe2 (also known as the forward bias voltage) for Q2 will be less than the base-to-emitter voltage Vbe1 for Q1 for the same amount of current flowing through them. Since the bases of Q1 and Q2 are shorted together and since nodes A and B are driven by the opamp 102 to have substantially the same voltage, the difference between Vbe1 and Vbe2 will appear as a difference voltage ΔVbe across resistor R1, where ΔVbe is proportional to the thermal voltage V_{T} and the emitter area ratio of Q1 and Q2 (i.e., m). Since the current through resistor R1 is equal to the current through resistor R2, the voltage across R2 will be

$$\frac{R 2}{R 1} Δ Vbe ,$$

As such, the bandgap voltage Vbg at the output node of the bandgap circuit 100 is given by Equation (1):

$$Vbg = Vbe 3 + \frac{R2}{R 1} Δ Vbe$$

where Vbe3 is the base-to-emitter voltage of device Q3 (typically about 0.7V at room temperature). In an ideal implementation, Vbg is approximately equal to 1.25V, which is the same as the bandgap of silicon.

It is known that the temperature coefficient of Vbe3 in equation (1) is negative (typically about −2 mV/° C.), while the temperature coefficient of ΔVbe is positive. By selecting appropriate resistance values for R1 and R2, the bandgap output voltage Vbg from the bandgap circuit 100 can be made significantly impervious to variations in operating temperature.

Unfortunately, the operation of the bandgap circuit 100 is susceptible to process variations, especially as transistor technologies get smaller and smaller. For example, unpredictable process-based differences (commonly referred to as process mismatch) between the sizes (device width (W) and/or length (L) mismatches) of the two CMOS devices (not shown in FIG. 1) that form the input pair of the opamp 102 and/or in the sizes of the CMOS devices that form the load in opamp 102 can produce an undesired offset voltage Vos that results in the bandgap voltage Vbg being given by Equation (2):

$$Vbg = Vbe 3 + \frac{R 2}{R 1} Δ Vbe + \frac{R 2}{R 1} Vos . \qquad ( 2 )$$

Additional undesired offset voltages can be produced by other process mismatches in the opamp 102, such as threshold voltage (Vt) mismatches and mobility mismatches. Further undesired offset voltages can be produced by still other process mismatches in the bandgap circuit 100, such as current-mirror mismatches between devices MP1, MP2, and MP3.

Since process mismatch is inversely proportional to the square root of transistor area, one way to reduce such process mismatch is to use transistors with relatively large widths and lengths, by keeping the same width-to-length ratio, but this solution undesirably increases the overall area of the integrated circuit. Other techniques for handling undesired offset voltages include integrated circuit testing to characterize the process mismatches followed by trimming procedures to compensate for the characterized process mismatches. Such chip-by-chip testing and trimming can add considerably to the time and cost of manufacturing.

### BRIEF DESCRIPTION OF THE DRAWINGS

Embodiments of the invention will become more fully apparent from the following detailed description, the appended claims, and the accompanying drawings in which like reference numerals identify similar or identical elements.

FIG. 1 is a schematic circuit diagram of a conventional bandgap circuit; and

FIG. 2 is a schematic circuit diagram of a bandgap circuit according to one embodiment of the invention.

### DETAILED DESCRIPTION

Detailed illustrative embodiments of the present invention are disclosed herein. However, specific structural and functional details disclosed herein are merely representative for purposes of describing example embodiments of the present invention. The present invention may be embodied in many alternate forms and should not be construed as limited to only the embodiments set forth herein. Further, the terminology used herein is for the purpose of describing particular embodiments only and is not intended to be limiting of example embodiments of the invention.

As used herein, the singular forms “a,” “an,” and “the,” are intended to include the plural forms as well, unless the context clearly indicates otherwise. It further will be understood that the terms “comprises,” “comprising,” “includes,” and/or “including,” specify the presence of stated features, steps, or components, but do not preclude the presence or addition of one or more other features, steps, or components. It also should be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

In one embodiment, the invention is a bandgap circuit for generating a bandgap voltage based on a first voltage having a negative temperature coefficient and a second voltage having a positive temperature coefficient. The bandgap circuit comprises first circuitry that generates the first voltage and second circuitry that generates the second voltage. The second circuitry comprises a first resistor having two terminals and first and second transistors that are connected to generate and apply the second voltage across the two terminals of the first resistor. The first and second transistors are input devices of an amplifier in the bandgap circuit that causes current to be driven through the first resistor to maintain the two terminals of the first resistor at two different voltage levels corresponding to the second voltage.

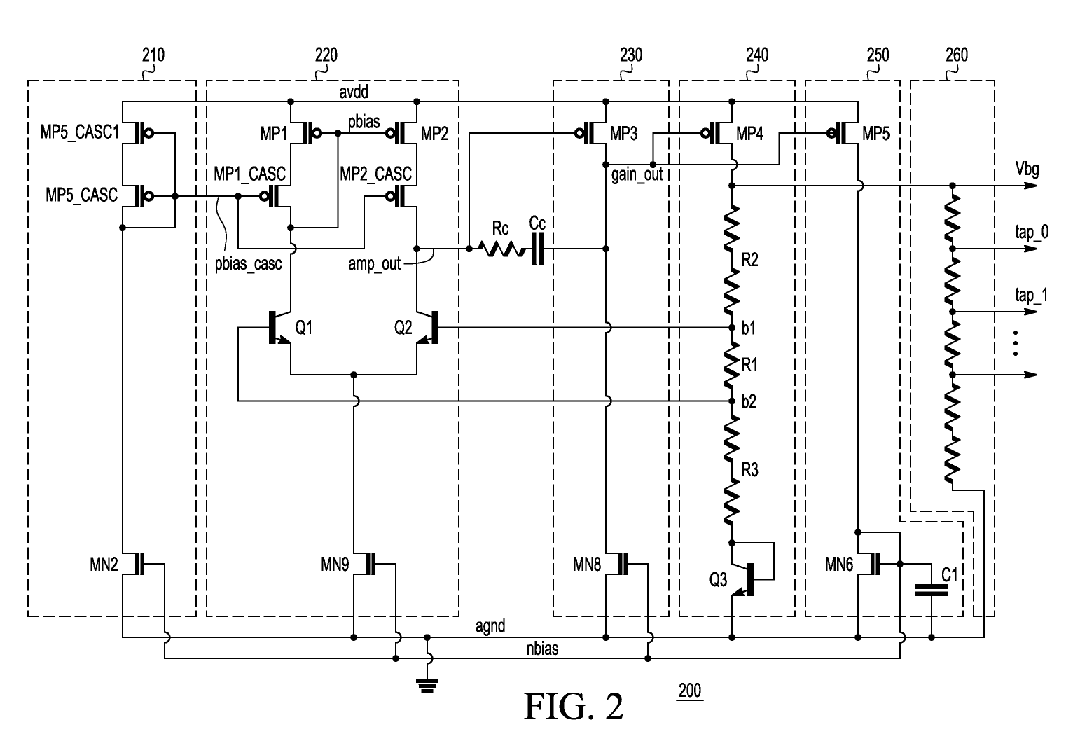

FIG. 2 is a schematic circuit diagram of a bandgap circuit 200 according to one embodiment of the invention. As shown in FIG. 2, the bandgap circuit 200, which generates bandgap voltage Vbg, includes a cascode generation stage 210, an amplifier stage 220, a gain stage 230, an output stage 240, a bias stage 250, and an optional resistor-chain stage 260.

The amplifier stage 220 includes NPN bipolar transistor devices Q1 and Q2 configured with their emitters shorted together and their bases respectively connected to the two terminals b1 and b2 of a resistor R1 in the output stage 240. The amplifier stage 220 also includes current-mirror PMOS devices MP1 and MP2, which generate the currents flowing through Q1 and Q2, respectively. In one implementation, MP2 is larger than MP1 such that the current through MP2 is M times larger than the current through MP1, whereMis greater than one. In addition, the amplifier stage 220 includes cascode PMOS devices MP1_CASC and MP2_CASC, which increase the output resistance of the amplifier stage 220. Devices Q1 and Q2 function as input devices for the amplifier stage 220, while devices MP1, MP2, MP1_CASC, and MP2_CASC provide the load of the amplifier stage 220.

The cascode generation stage 210 generates a bias voltage pbias_casc, which is applied to the gates of MP1_CASC and MP2_CASC.

In one implementation, Q1 and Q2 aree the same size. Because the current flowing through Q2 is M times larger than the current flowing through Q1, and because the emitters of Q1 and Q2 are shorted together, the base of Q2 (i.e., the voltage at terminal b1 of resistor R1) is forced to be at a higher voltage level than the base of Q1 (i.e., the voltage at terminal b2 of resistor R1). The corresponding voltage difference ΔVbe, which is the difference between the base-to-emitter voltages (Vbe) of Q1 and Q2, gets applied across resistor R1, such that the current Iptat flowing across resistor R1 is given by Equation (3) as follows:

$$Iptat = \frac{Δ Vbe}{R 1} . \qquad ( 3 )$$

As such, the bandgap voltage Vbg for the bandgap circuit 200 is given by Equation (4) as follows:

$$Vbg = Vbe 3 + \frac{( R 1 + R 2 + R 3 )}{R 1} Δ Vbe , \qquad ( 4 )$$

where Vbe3 is the base-to-emitter voltage of device Q3.

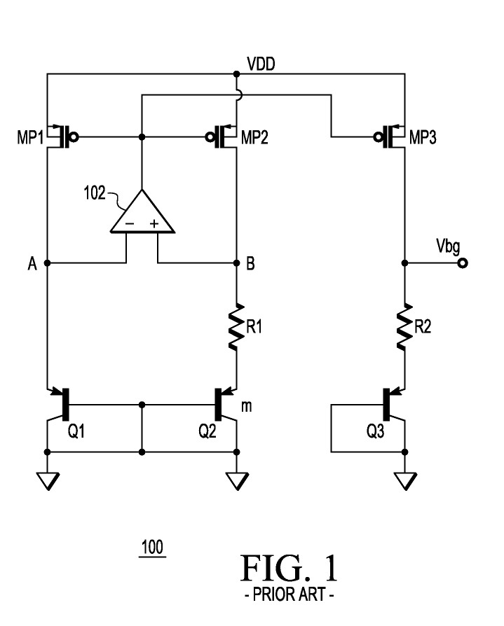

As in the bandgap circuit 100 of FIG. 1, Vbe3 for the bandgap circuit 200 has a negative temperature coefficient, while ΔVbe has a positive temperature coefficient. By selecting appropriate values for R1, R2, and R3, the output voltage Vbg of the bandgap circuit 200 can be made substantially impervious to variations in operating temperature and process, while achieving a desired level for the bandgap voltage Vbg.

In one possible implementation:

R1=6.156 Kohms;

R2=36.936 Kohms (i.e., 6*R1);

R3=24.624 Kohms (i.e., 4*R1);

Vbe3=0.688V (at room temperature);

W/L ratio of MP2=6*W/L ratio of MP1;

ΔVbe=47.1 mV;

Putting all the above values in Equation (4) gives:

Vbg=1.2061V.

The output signal amp_out from the amplifier stage 220 is applied to the gain stage 230, whose output signal gain_out is applied to output-stage pMOS transistor device MP4 in the output stage 240. In this way, the amplifier stage 220, the gain stage 230, and the output stage 240 combine to ensure a sufficient voltage gain which ensures that a current is driven through the resistor R1 to maintain the voltages at the terminals b1 and b2 as required by the NPN devices Q2 and Q1, respectively, and thus generating a desired voltage difference ΔVbe.

Compensation resistor Rc and compensation capacitor Cc function as stabilization circuitry that inhibits oscillations within the bandgap circuit 200.

The bias stage 250 provides a bias voltage nbias used to bias NMOS transistor devices MN2, MN8, and MN9. As such, the bandgap circuit 200 is self-biased, i.e., the current Iptat is used to bias the cascode generation stage 210, the amplifier stage 220, and the gain stage 230, and the bandgap circuit 200 does not require a separate current reference.

In the bandgap circuit 100 of FIG. 1, PNP bipolar devices Q1 and Q2 generate the voltage difference ΔVbe, and the bandgap circuit 100 has a separate amplifier, i.e., CMOS-based opamp 102. In the bandgap circuit 200, NPN bipolar devices Q1 and Q2 both (i) generate the voltage difference ΔVbe and (ii) function as the input devices to the amplifier stage 220. Because bipolar devices are less susceptible to process mismatch as compared to CMOS devices, the bandgap circuit 200 will have smaller process-mismatch offset voltages than the bandgap circuit 100.

In the bandgap circuit 200, MP1 and MP2 have difference sizes, while Q1 and Q2 have the same size. In alternative implementations, Q1 and Q2 can have different sizes (with Q1 being bigger than Q2), while MP1 and MP2 have the same size. In other alternative embodiments, Q1 and Q2 have different sizes and MP1 and MP2 also has different sizes. In all of these different implementations, due to different current densities in Q1 and Q2, the base voltages of Q1 and Q2 are different, and a voltage difference ΔVbe gets applied across the resistor R1.

Although the bandgap circuit 200 is designed to generate a bandgap voltage Vbg having a specific level, e.g., 1.2061V, lower reference voltages can be generated by applying the bandgap voltage Vbg to a suitable output resistance chain that functions as a voltage divider.

As shown in FIG. 2, the bandgap circuit 200 can have an optional resistance-chain stage 260 that includes a series of resistors connecting the bandgap voltage node Vbg to ground and a set of one or more taps that can be accessed to provide a set of one or more voltages at different levels between the bandgap voltage Vbg and ground, where the different voltage levels depend on the resistance values along the resistor chain. Alternatively, diode-connected nMOS or pMOS transistors can be used in place of resistors in the resistance-chain stage 260 to provide one or more voltages less than the bandgap voltage Vbg.

The bandgap circuit 200 does not require high supply voltages for proper operation and can instead be implemented using relatively low supply voltage levels, such as 1.8V.

For purposes of this description, the terms “couple,” “coupling,” “coupled,” “connect,” “connecting,” or “connected” refer to any manner known in the art or later developed in which energy is allowed to be transferred between two or more elements, and the interposition of one or more additional elements is contemplated, although not required. Conversely, the terms “directly coupled,” “directly connected,” etc., imply the absence of such additional elements.

Also, for purposes of this disclosure, it is understood that all gates are powered from a fixed-voltage power domain (or domains) and ground unless shown otherwise. Accordingly, all digital signals generally have voltages that range from approximately ground potential to that of one of the power domains and transition (slew) quickly. However and unless stated otherwise, ground may be considered a power source having a voltage of approximately zero volts, and a power source having any desired voltage may be substituted for ground. Therefore, all gates may be powered by at least two power sources, with the attendant digital signals therefrom having voltages that range between the approximate voltages of the power sources.

Signals and corresponding nodes, ports, or paths may be referred to by the same name and are interchangeable for purposes here.

Transistors are typically shown as single devices for illustrative purposes. However, it is understood by those with skill in the art that transistors will have various sizes (e.g., gate width and length) and characteristics (e.g., threshold voltage, gain, etc.) and may consist of multiple transistors coupled in parallel to get desired electrical characteristics from the combination. Further, the illustrated transistors may be composite transistors.

Unless explicitly stated otherwise, each numerical value and range should be interpreted as being approximate as if the word “about” or “approximately” preceded the value or range.

It will be further understood that various changes in the details, materials, and arrangements of the parts which have been described and illustrated in order to explain embodiments of this invention may be made by those skilled in the art without departing from embodiments of the invention encompassed by the following claims.

In this specification including any claims, the term “each” may be used to refer to one or more specified characteristics of a plurality of previously recited elements or steps. When used with the open-ended term “comprising,” the recitation of the term “each” does not exclude additional, unrecited elements or steps. Thus, it will be understood that an apparatus may have additional, unrecited elements and a method may have additional, unrecited steps, where the additional, unrecited elements or steps do not have the one or more specified characteristics.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments necessarily mutually exclusive of other embodiments. The same applies to the term “implementation.”

1. A bandgap circuit for generating a bandgap voltage based on a first voltage having a negative temperature coefficient and a second voltage having a positive temperature coefficient, the bandgap circuit comprising:
first circuitry that generates the first voltage; and
second circuitry that generates the second voltage, wherein the second circuitry comprises:
a first resistor having two terminals; and
first and second transistors that are connected to generate and apply the second voltage across the two terminals of the first resistor, wherein the first and second transistors are input devices of an amplifier in the bandgap circuit that causes current to be driven through the first resistor to maintain the two terminals of the first resistor at two different voltage levels corresponding to the second voltage.

2. The bandgap circuit of claim 1, wherein:
the first and second transistors are configured such that mirrored currents flow through the first and second transistors;
the first and second transistors are bipolar devices having their emitters shorted together and their bases respectively connected to the two terminals of the first resistor; and
the first and second transistors are sized such that the mirrored currents result in the first and second transistors having different current densities and different base-to-emitter voltages, such that the second voltage across the two terminals of the first resistor results from the bases of the first and second transistors having different voltages due to the emitters of the first and second transistors being shorted together.

3. The bandgap circuit of claim 2, wherein the first and second transistors are NPN bipolar devices.

4. The bandgap circuit of claim 3, wherein the first circuitry comprises a NPN bipolar device connected in series with the first resistor.

5. The bandgap circuit of claim 4, wherein the first resistor is connected in series between second and third resistors.

6. The bandgap circuit of claim 1, wherein the amplifier comprises:
the first and second transistors functioning as the input devices to the amplifier; and
a load comprising first and second current-mirror transistors connected to generate mirrored currents through the first and second transistors.

7. The bandgap circuit of claim 6, wherein:
the load further comprises first and second cascode transistors connected to increase output resistance of the load; and
the bandgap circuit further comprises a cascode generation stage connected to generate a bias voltage applied to the gates of the first and second cascode transistors.

8. The bandgap circuit of claim 1, further comprising:
a gain stage connected to receive an amplifier output signal from the amplifier and generate a gain-stage output signal; and
an output stage comprising, and connected in series, the first circuitry, the first resistor, and an output-stage device,
wherein the gain-stage output signal is applied to the gate of the output-stage device to generate the current flowing through the first resistor to drive the two terminals of the first resistor to maintain the two different voltage levels corresponding to the second voltage.

9. The bandgap circuit of claim 8, wherein the output stage further comprises one or more additional series-connected resistances.

10. The bandgap circuit of claim 8, further comprising stabilization circuitry connected between the amplifier and the gain stage to inhibit oscillations within the bandgap circuit.

11. The bandgap circuit of claim 1, further comprising a bias stage connected to provide bias current for one or more other stages in the bandgap circuit such that the bandgap circuit is self-biased.

12. The bandgap circuit of claim 1, further comprising a resistance-chain stage connected between the bandgap voltage and ground to provide one or more voltage levels between the bandgap voltage and ground.

13. The bandgap circuit of claim 12, wherein the resistance-chain stage comprises a series of resistors connected between the bandgap voltage and ground.

14. The bandgap circuit of claim 12, wherein the resistance-chain stage comprises a series of diode-connected transistors connected between the bandgap voltage and ground.
